(19) United States
(12) Patent Application Publication
(10) Pub. No.: US 2026/0171550 A1
(43) Pub. Date: Jun. 18, 2026

(54) STRUCTURAL THERMAL BARRIER AND METHOD

(71) Applicant: ASPEN AEROGELS, INC., Northborough, MA (US)

(72) Inventors: John Williams, Northborough, MA (US); Younggyu Nam, Northborough, MA (US); Christopher Stow, Northborough, MA (US); Lixin Wang, Northborough, MA (US)

(21) Appl. No.: 19/126,243

(22) PCT Filed: Nov. 14, 2023
(86) PCT No.: PCT/US2023/037270

§ 371 Date: Apr. 30, 2025

Related U.S. Application Data
(60) Provisional application No. 63/425,939, filed on Nov. 16, 2022.

(51) Int. Cl. H01M 10/658; H01M 10/0525; H01M 10/647; H01M 50/209; H01M 50/211; H01M 50/271; H01M 50/293

(52) U.S. Cl. CPC H01M 10/658; H01M 10/0525; H01M 10/647; H01M 50/209; H01M 50/211; H01M 50/271; H01M 50/293

(57) ABSTRACT

A battery module, and associated methods are disclosed. In one example, a battery module includes thermal isolation structures with a structural support plate and an aerogel layer. Examples of thermal isolation structures are shown that include a module cover contact located on a top end of a structural support plate.

### CLAIM OF PRIORITY

This patent application claims the benefit of priority to U.S. Provisional Patent Application Ser. No. 63/425,939, entitled “STRUCTURAL THERMAL BARRIER AND METHOD,” filed on Nov. 16, 2022, which is hereby incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Aspects described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### BRIEF DESCRIPTION OF THE DRAWINGS

FIG. 1 shows an isometric view of a battery module in accordance with some aspects.

FIG. 2 shows a cross section view of the battery module along line AA′ in FIG. 1 in accordance with some aspects.

FIG. 3 shows selected portions of another battery module in accordance with some aspects.

FIG. 4 shows selected portions of another battery module in accordance with some aspects.

FIGS. 5A and 5B show cross section views of thermal isolation structure along line BB′ in FIG. 4 in accordance with some aspects.

FIGS. 5C and 5D show cross section views of thermal isolation structure along line CC′ in FIG. 4 in accordance with some aspects.

FIG. 6 shows a cross section view of a selected portion 460 of the thermal isolation structure in FIG. 4 in accordance with some aspects.

FIG. 7A shows an exploded view of assembly of components of a thermal isolation structure in accordance with some aspects.

FIG. 7B shows another exploded view of assembly of components of a thermal isolation structure in accordance with some aspects.

FIG. 8A shows an exploded view of components of a thermal isolation structure in accordance with some aspects.

FIG. 8B shows the thermal isolation structure of FIG. 8A in an assembled state in accordance with some aspects.

FIG. 9A shows an exploded view of components of a thermal isolation structure in accordance with some aspects.

FIG. 9B shows the thermal isolation structure of FIG. 9A in an assembled state in accordance with some aspects.

FIG. 10A shows a thermal isolation structure in accordance with some aspects.

FIG. 10B shows another thermal isolation structure in accordance with some aspects.

FIG. 10C shows another thermal isolation structure in accordance with some aspects.

FIG. 11A shows a component of a thermal isolation structure in accordance with some aspects.

FIG. 11B shows a component of a thermal isolation structure in accordance with some aspects.

FIG. 11C shows assembled components of a thermal isolation structure in accordance with some aspects.

FIG. 12A shows a component of a thermal isolation structure in accordance with some aspects.

FIG. 12B shows an isometric view of assembled components of a thermal isolation structure in accordance with some aspects.

FIG. 12C shows an end view of the assembled components from FIG. 12B in accordance with some aspects.

FIG. 13A shows selected components of a thermal isolation structure in accordance with some aspects.

FIG. 13B shows an isometric view of an assembled component of a thermal isolation structure in accordance with some aspects.

FIG. 13C shows an end view of the assembled component from FIG. 13B in accordance with some aspects.

FIG. 14A shows selected components of a thermal isolation structure in accordance with some aspects.

FIG. 14B shows an isometric view of an assembled component of a thermal isolation structure in accordance with some aspects.

FIG. 14C shows an end view of the assembled component from FIG. 14B in accordance with some aspects.

FIG. 14D shows a close up view of an end of the assembled component in dashed box from FIG. 14C in accordance with some aspects.

FIG. 15A shows an exploded view of components of a thermal isolation structure in accordance with some aspects.

FIG. 15B shows the thermal isolation structure of FIG. 15A in an assembled state in accordance with some aspects.

FIG. 15C shows another aspect of the thermal isolation structure of FIG. 15A in an assembled state including an additional component layer in accordance with some aspects.

FIG. 16 shows selected sheet components of a thermal isolation structure in accordance with some aspects.

FIG. 17A shows a thermal isolation structure in accordance with some aspects.

FIG. 17B shows a cross section view of the thermal isolation structure along line CC′ from FIG. 17A in accordance with some aspects.

FIG. 17C shows selected portions of the thermal isolation structure in dashed box from FIG. 17B in accordance with some aspects.

FIG. 18 shows a method of forming a battery module in accordance with some aspects.

FIG. 19 shows an electronic device in accordance with some aspects.

FIG. 20 shows an electric vehicle in accordance with some aspects.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure is directed to an energy storage system including multiple battery cells and one or more thermal isolation structures disposed therebetween. The one or more thermal isolation structures prevent heat propagation and thermal runaway, which could cause potential fires, overheating, combustion, or other issues associated with high temperatures in such a battery module.

The thermal isolation structure comprises a structural support plate and one or more thermal isolation layers over the major surfaces of the structural support plate. The one or more thermal isolation layers prevent the heat transfer between the battery cells, while the structural support plate provide mechanical support for the thermal isolation layers. The thermal isolation structure may further comprise a containment film to encapsulate the one or more thermal isolation layer to prevent dust of the thermal isolation layer, a conductive layer to spread heat and prevent hot spot, and a module cover contact abutting the lid of the battery module housing to position the thermal isolation structure in the battery module.

The thermal isolation structure is discussed in detail below regarding its material, structure, components, and other related properties. Insulation materials, thermal conductor materials, resilient materials, etc. as described in examples below, can be used in battery modules to compartmentalize individual battery cells, or groups of battery cells in a battery device. Multiple battery cells that are coupled together are referred to in the present disclosure as battery modules. However, devices and methods described can be used in any of several types of multiple battery cell arrangements, that may be termed battery packs, battery systems, etc.

### Thermal Isolation Layer

Thermal isolation layer as described below can be used as a single heat resistant layer, or in combination with other layers that provide additional function to a multilayer configuration, such as mechanical strength, compressibility, heat dissipation/conduction, etc. Thermal isolation layers described herein are responsible for reliably containing and controlling heat flow from heat-generating parts in small spaces and to provide safety and prevention of fire propagation for such products in the fields of electronic, industrial and automotive technologies.

In many embodiments of the present disclosure, the thermal isolation layer functions as a flame/fire deflector layer either by itself or in combination with other materials that enhance performance of containing and controlling heat flow. For example, the thermal isolation layer may itself be resistant to flame and/or hot gases and further include entrained particulate materials that modify or enhance heat containment and control. One aspect of a highly effective thermal isolation layer includes an aerogel. Aerogels describe a class of material based upon their structure, namely low density, open cell structures, large surface areas (often 900 m²/g or higher) and subnanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers may also be used in examples of the present disclosure.

Selected examples of aerogel formation and properties are described. In several examples, a precursor material is gelled to form a network of pores that are filled with solvent. The solvent is then extracted, leaving behind a porous matrix. A variety of different aerogel compositions are known, and they may be inorganic, organic and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic acrogels can also be made from melamine formaldehydes, resorcinol formaldehydes, and the like.

In one example, aerogel materials may be monolithic, or continuous throughout a structure or layer. In other examples, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, etc. and then dried to form a composite aerogel structure.

### Reinforcement of the Thermal Isolation Layer

As noted above, an aerogel may be organic, inorganic, or a mixture thereof. In some examples, the aerogel includes a silica-based aerogel. One or more layers in a thermal barrier may include a reinforcement material. The reinforcing material may be any material that provides resilience, conformability, or structural stability to the aerogel material. Examples of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

Fiber reinforcement materials can comprise a range of materials, including, but not limited to: Polyesters, polyolefin terephthalates, poly(ethylene) naphthalate, polycarbonates (examples Rayon, Nylon), cotton, (e.g. lycra manufactured by DuPont), carbon (e.g. graphite), polyacrylonitriles (PAN), oxidized PAN, pre-oxidized PAN, uncarbonized heat treated PANs (such as those manufactured by SGL carbon), glass or fiberglass based material (like S-glass, 901 glass, 902 glass, 475 glass, E-glass) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), Silicon carbide fibers like Nicalon (manufactured by COI Ceramics), ceramic fibers like Nextel (manufactured by 3M), Acrylic polymers, fibers of wool, silk, hemp, leather, suede, PBO—Zylon fibers (manufactured by Tyobo), Liquid crystal material like Vectan (manufactured by Hoechst), Cambrelle fiber (manufactured by DuPont), Polyurethanes, polyamaides, Wood fibers, Boron, Aluminum, Iron, Stainless Steel fibers and other thermoplastics like PEEK, PES, PEL, PEK, PPS.

The glass or fiberglass-based fiber reinforcement materials may be manufactured using one or more techniques. In certain aspects, it is desirable to make them using a carding and cross-lapping or air-laid process. In exemplary aspects, carded and cross-lapped glass or fiberglass-based fiber reinforcement materials provide certain advantages over air-laid materials. In one aspect, carded and cross-lapped glass or fiberglass-based fiber reinforcement materials can provide a consistent material thickness for a given basis weight of reinforcement material. In certain additional aspects, it is desirable to further needle the fiber reinforcement materials with a need to interlace the fibers in z-direction for enhanced mechanical and other properties in the final aerogel composition.

### Structural Support Plate

In addition to the thermal isolation layer, the structural support plate in combination with thermal isolating layer are effective at protecting the components adjacent to the battery stacks (e.g., a passenger compartment in an electrical vehicle) in a thermal runaway event. The structural support plate mechanically supports the thermal isolation layer. In addition, the structural support plate effectively protects components of the battery and its associated electrical devices from the bombardment of the particles in the thermal runaway ejecta. Aspects of rigid materials used in the structural support plate include, but are not limited to, mica, carbon fiber, graphite, silicon carbide, copper, stainless steel, aluminum, titanium, other metals, titanium alloys, other metal alloys, and combinations thereof.

### Thermal Conductive Layers

In addition to thermal isolation layers, thermally conductive layers in combination with thermal isolation layers are effective at channeling unwanted heat to a desired external location, such as external heat dissipating fins, a heat dissipating housing, or other external structure to dissipate unwanted heat to outside ambient air. In one example, a thermally conductive layer or layers helps to dissipate heat away from a localized heat load within a battery module or pack. Examples of high thermal conductivity materials include carbon fiber, carbon nanotubes, graphene, graphite, pyrolytic graphite sheets, silicon carbide, metals including but not limited to copper, stainless steel, aluminum, and the like, as well as combinations thereof.

To aid in the distribution and removal of heat by, in at least one embodiment the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. For example, at least one thermally conductive layer of the multilayer materials disclosed herein can be in thermal communication with an element of a cooling system of a battery module or pack, such as a cooling plate or cooling channel of the cooling system. For another example, at least one thermally conductive layer can be in thermal communication with other elements of the battery pack, battery module, or battery system that can function as a heat sink, such as the walls of the pack, module or system, or with other ones of the multilayer materials disposed between battery cells. Thermal communication between the thermally conductive layer and heat sink elements within the battery system can allow for removal of excess heat from the cell or cells adjacent to the multilayer material to the heat sink, thereby reducing the effect, severity, or propagation of a thermal event that may generate excess heat. In addition to removal of heat, a thermally conductive layer can spread, or dissipate heat from a region of high heat concentration to a larger region of lower heat concentration.

In addition to thermal insulating layers, and thermal conductive layers one or more resilient material layers may also be included adjacent to cells or between cells. In one example, a resilient layer absorbs any volume expansion during the regular operation of one or more battery cells. In one aspect during a charge, the cells may expand, and during a discharge, the cells may shrink. In one example, the resilient layer may also absorbs permanent volume expansion caused by any battery cell degradation and/or thermal runaway. Resilient material layers may include, but are not limited to, foam, fiber, fabric, sponge, spring structures, rubber, polymer, etc.

### Thermal Isolation Structures in a Battery Module

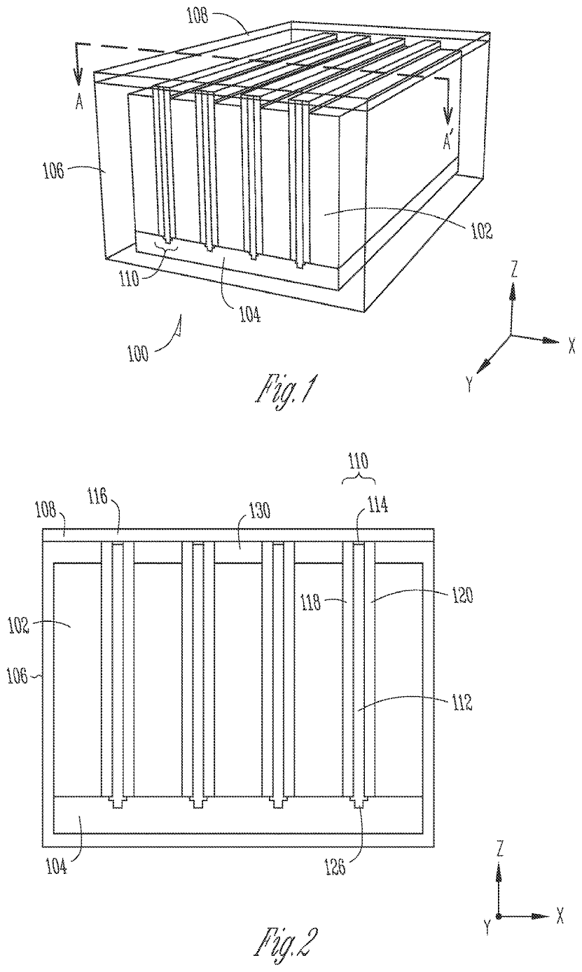

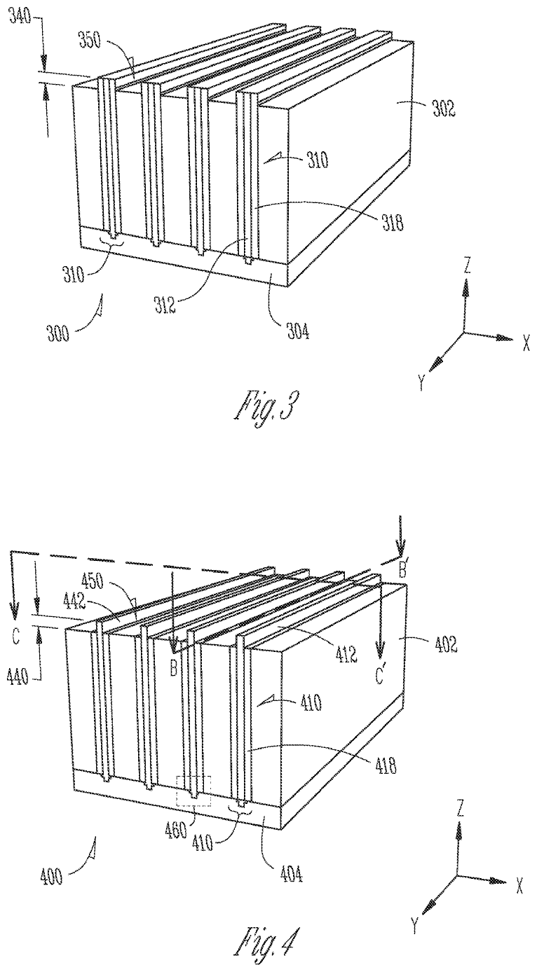

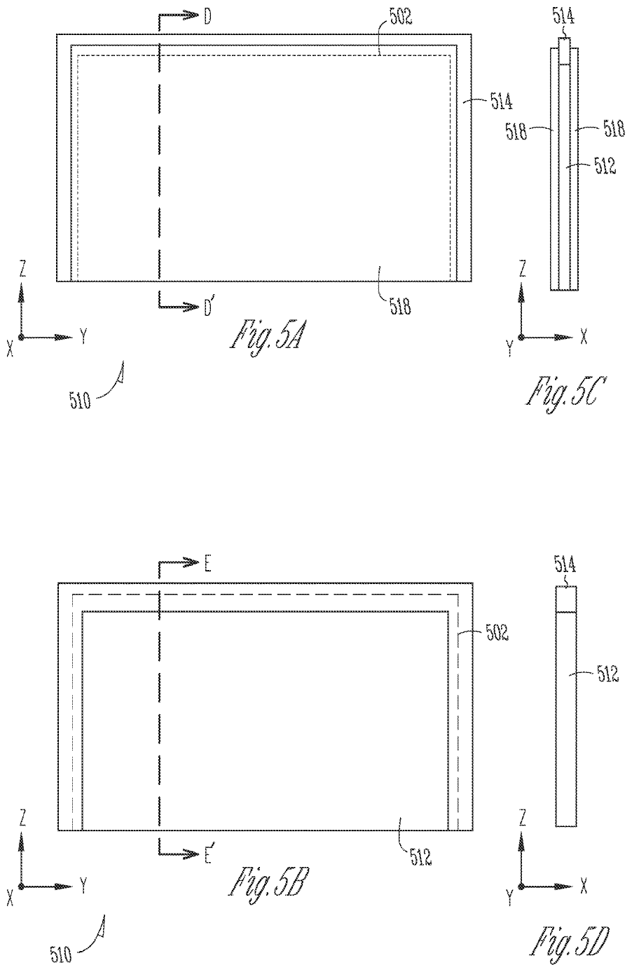

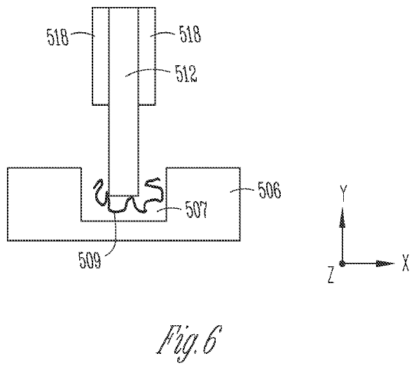

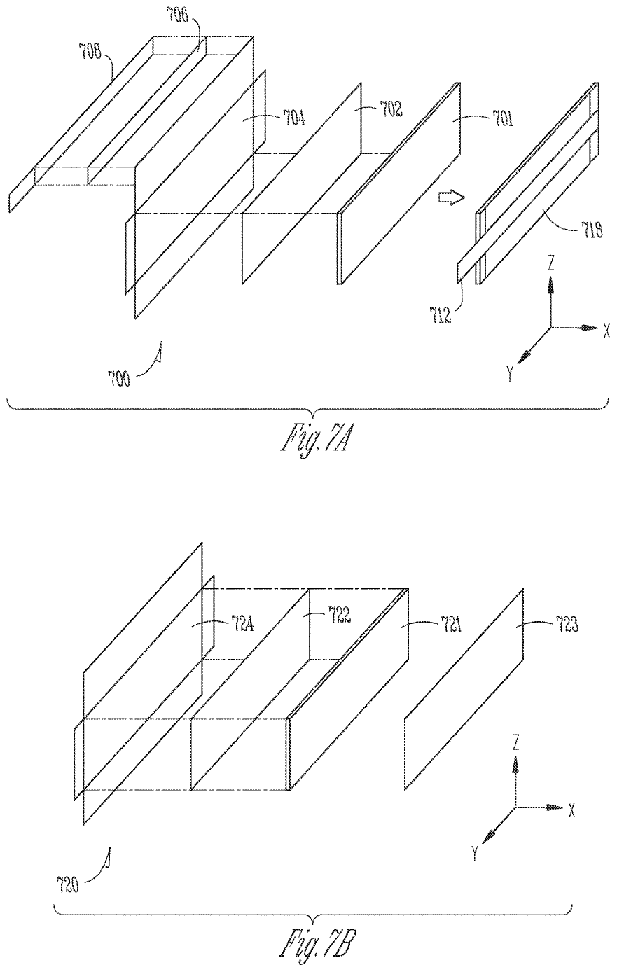

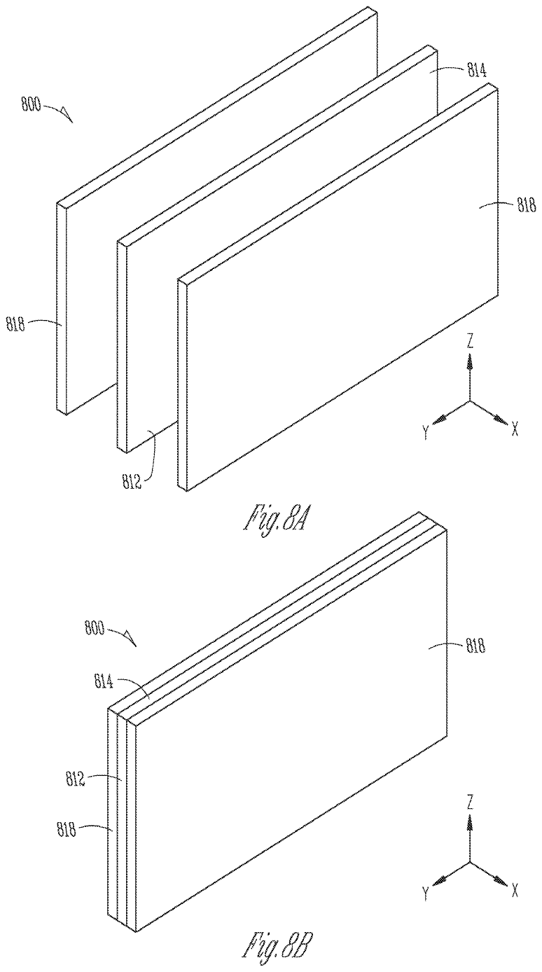

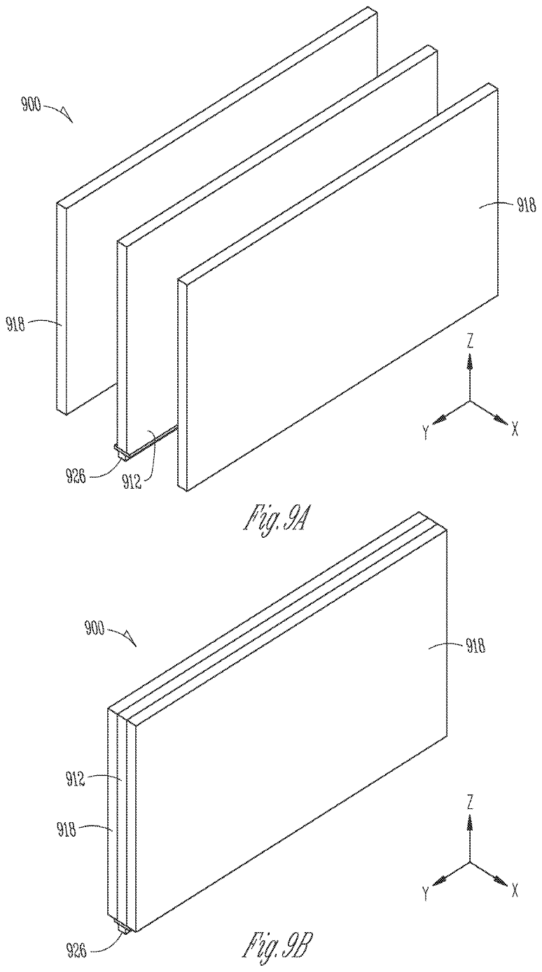

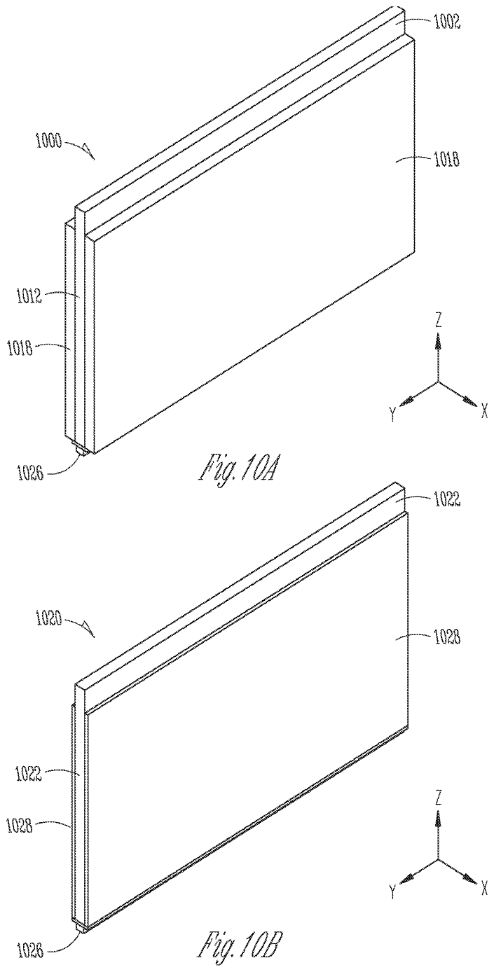

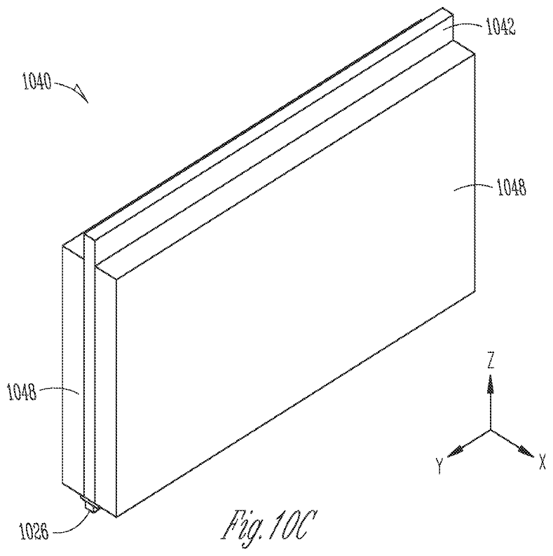

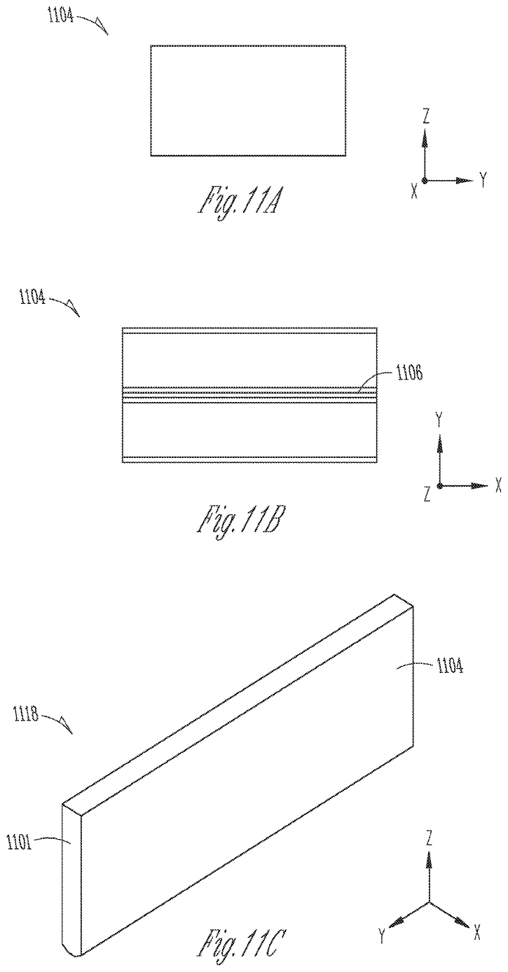

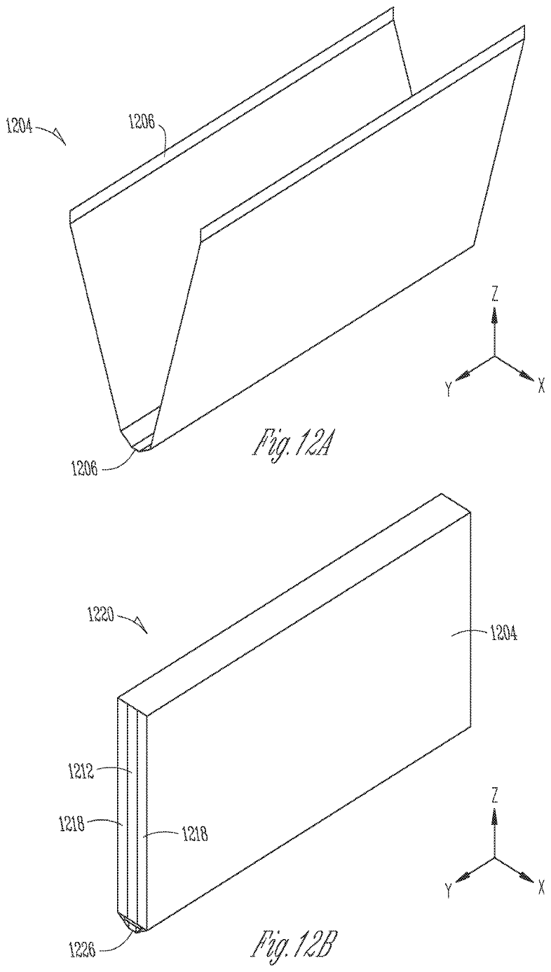

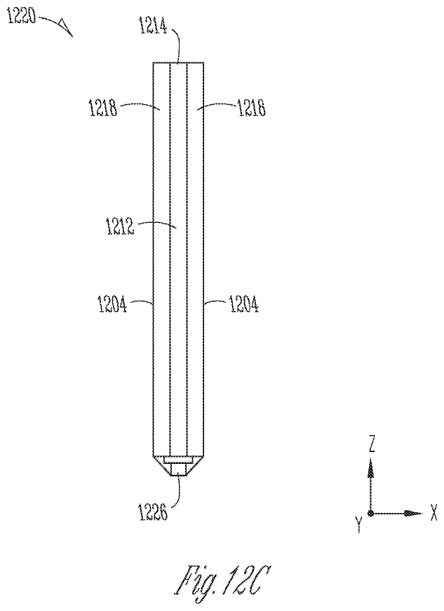

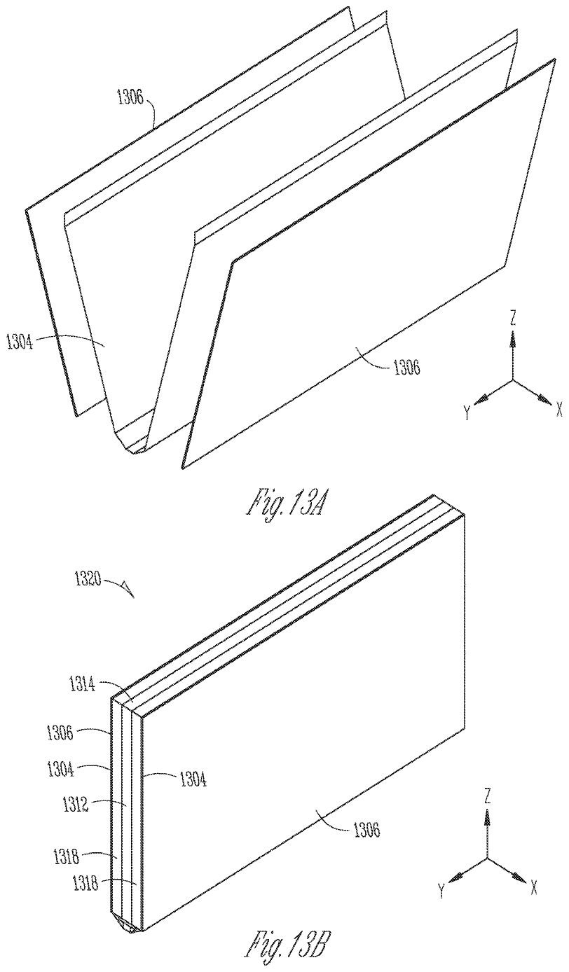

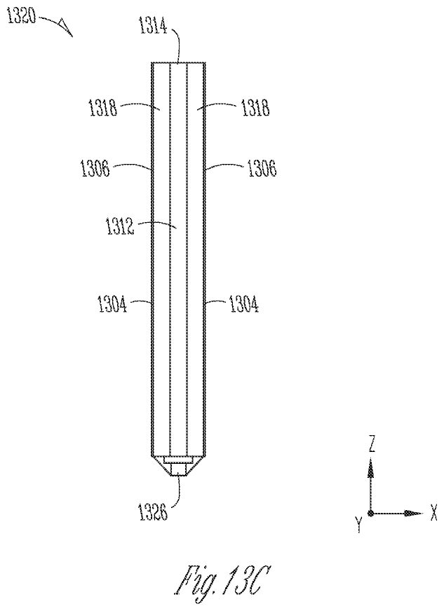

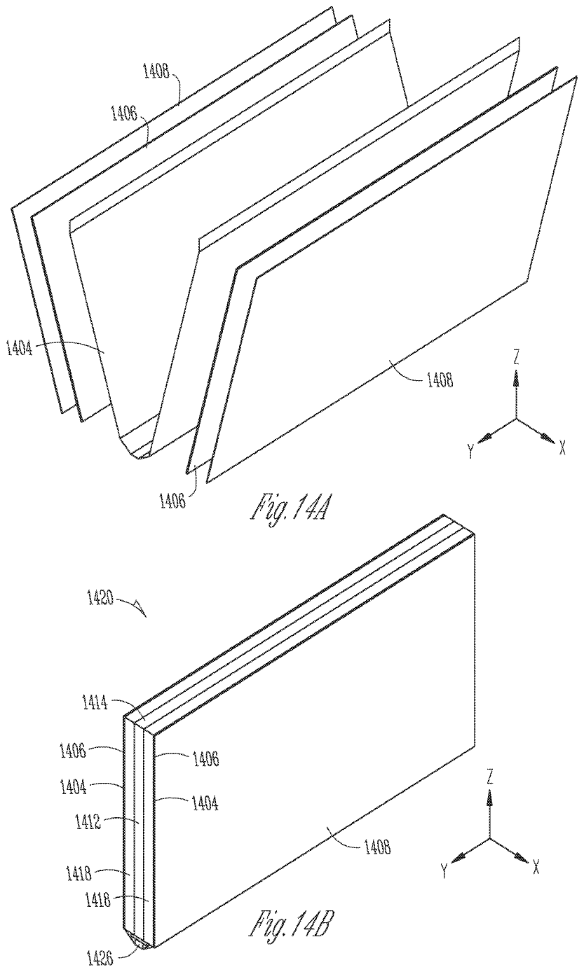

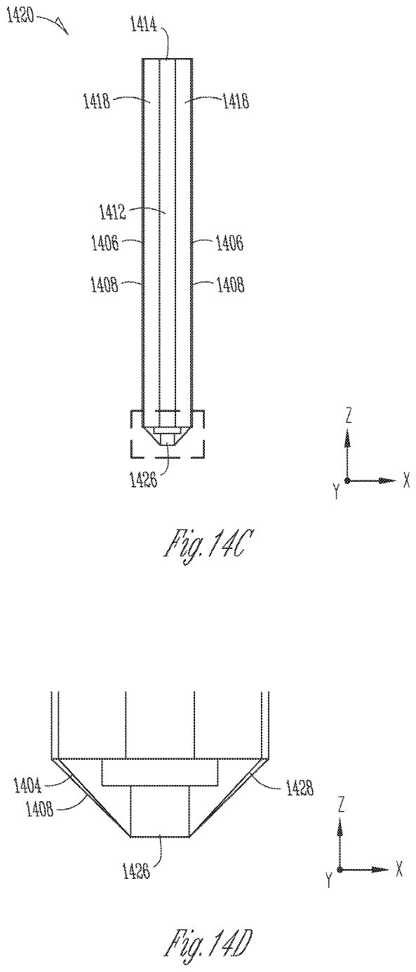

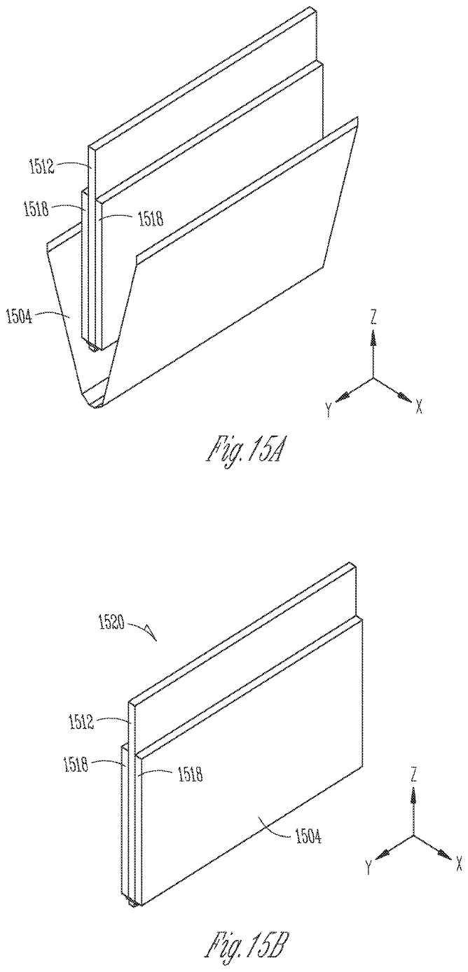

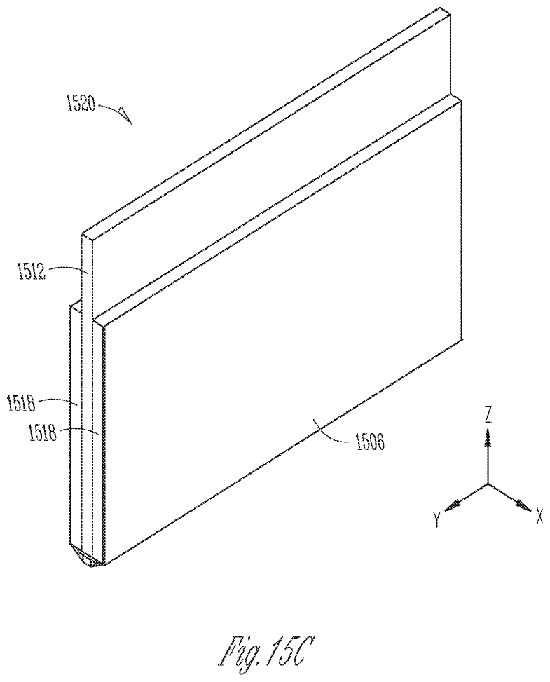

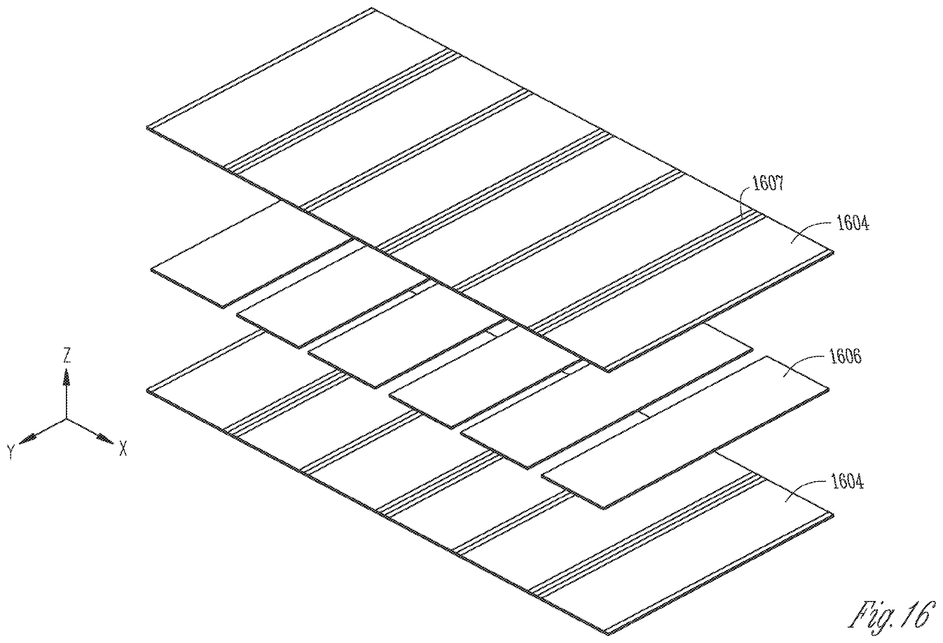

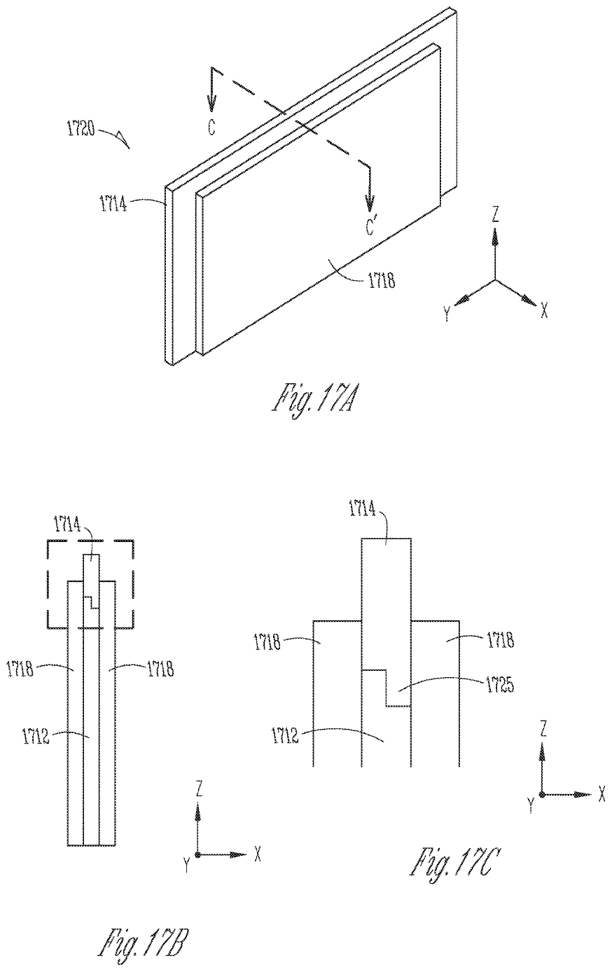

FIG. 1 shows one aspect of a battery module 100. The module 100 includes a stack of battery cells 102. Battery cells are also referred to as cells hereafter. In one example, the stack of cells 102 includes lithium ion cells 102. Several configurations of lithium ion cells 102 are possible. In one example, the stack of lithium ion cells 102 includes lithium ion pouch cells or prismatic cell, although the invention is not so limited. A heat sink 104 is shown located on a side of the battery module 100, and in thermal communication with the battery cells 102. In the aspect of FIG. 1, the stack of battery cells 102 are located within a module housing 106. A module cover 108 is further shown enclosing the stack of battery cells 102 within the module housing 106.

One or more thermal isolation structures 110 are shown between at least two cells in the stack of battery cells 102. In the aspect of FIG. 1, a thermal isolation structure 110 is included between each cell in the stack of battery cells 102, although the invention is not so limited. In one example, groups of cells 102 are separated by one or more thermal isolation structures 110. Inclusion of one or more thermal isolation structures 110 provides a level of increased safety in the event of a thermal runaway in one or more of the cells 102. If a thermal runaway event occurs, a region affected by destruction of a failed cell 102 is contained to a region between thermal isolation structures 110 and/or the module housing 106. Improved thermal isolation structures 110 are desired to better isolate and protect adjacent regions within a battery module 100 in the event of thermal runaway in one or more individual cells 102.

A heat sink 104 is shown in FIG. 1. Examples of heat sinks 104 include, but are not limited to, passive heat sinks such as metal plates, and active heat sinks such as fluid recirculation systems that remove heat to a remote location. In the aspect of FIG. 1, one or more thermal isolation structures 110 interlock with the heat sink within a slot or other recess. In one example, the heat sink 104 is a separate component contained within the module housing 106. In one example, the heat sink 104 is integral with a bottom surface of the module housing 106.

FIG. 2 shows a cross section view of the battery module 100 along line AA′ from FIG. 1. A thermal isolation structure 110 is shown including a structural support plate 112. The thermal isolation structure 110 also includes a module cover contact 114 located on a top end of the structural support plate 112. A thermal isolation layer 118 is shown coupled to one side of the structural support plate 112. In the aspect of FIG. 2, a second thermal isolation layer 120 is shown coupled to an opposite side of the structural support plate 112 from the thermal isolation layer 118.

As shown in FIG. 2, at least some of the cells 102 are separated by thermal isolation structures 110. A space 130 is shown above the cells 102 within the module housing 106 and the module cover 108. In the event of a thermal runaway, gasses may vent into the space 130 above a cell 102. In one example cells 102 include a vent (not shown) that specifically directs gasses into the space 130. In such an event, it is desirable to contain the hot gasses, and keep them from affecting adjacent cells 102. The module cover contact 114 of the thermal isolation structures 110 provide closure of the space 130 against the module cover 108. In one example, the module cover contact 114 includes a flat surface, although the invention is not so limited. Other shapes of module cover contact 114 include a triangular shape, a rounded taper to the structural support plate 112, etc.

In one example, one or more components or portions of the thermal isolation structure 110 is formed from an intumescent material. Intumescent materials expand in volume when exposed to heat. In one example, the module cover contact 114 includes an intumescent material and/or an adhesive material. In one example, the structural support plate 112 includes an intumescent material. In one example, the module cover contact 114 and the structural support plate 112 include an intumescent material. In one example, the module cover contact 114 and the structural support plate 112 are integrally formed. In one example, the module cover contact 114 and the structural support plate 112 are separate components formed from different materials. Examples where the module cover contact 114 and the structural support plate 112 are separate components formed from different materials are discussed in more detail below, specifically with regard to FIGS. 5A, 5B and 6.

In the aspect of FIG. 2, one or more of the thermal isolation structures 110 includes a tab 126 that fits into a mating feature in the heat sink 104 or in a bottom of the module housing 106. The inclusion of a tab 126, as well as the wide module cover contact 114, provide a level of structural support that secures each thermal isolation structures 110 in place and increases an ability for each thermal isolation structures 110 to resist being moved out of place during a thermal runaway event of a cell 102. In one example, the inclusion of multiple thermal isolation structures 110 with module cover contacts 114 provides enough structural support to enable a design of the module housing 106 to be reduced and made lighter.

In one example, the inclusion of one or more thermal isolation layers 118, 120 keeps heat generated during a thermal runaway event isolated to a region of the failing cell 102. However high thermal isolation materials, such as aerogel materials, can be fragile. By securing one or more thermal isolation layers 118, 120 to a structural support plate 112, a composite thermal isolation structure 110 provides both mechanical stability from the structural support plate 112, and thermal isolation from the one or more thermal isolation layers 118, 120. The addition of a module cover contact 114 as described provides further structural stability of each thermal isolation structure 110 adjacent to the space 130 above cells 102.

In one example, a resilient pad 116 is included between the module cover contact 114 and the module cover 108. Inclusion of a resilient pad 116 accommodates some movement of components of the battery module 100 resulting from thermal expansion or other mechanisms, while still maintaining the advantages of cell isolation as discussed above.

FIG. 3 shows another aspect of portions of a battery module 300. In the aspect of FIG. 3, a number of cells 302 are shown. In the example, a heat sink 304 is included. A number of thermal isolation structures 310 are shown selectively separating one or more cells 302 within the stack of cells. The thermal isolation structures 310 include a structural support plate 312 similar to examples described above. One or more thermal isolation layers 318 are shown coupled to the structural support plate 312. In the aspect of FIG. 3, a protrusion height 340 of the thermal isolation structures 310 above a top surface of the cells 302 is shown. The structural support plate 312 and the thermal isolation layers 318 have the same protrusion height 340 in the aspects depicted in FIG. 3. The protrusion height 340 defines a space 350 where gas venting is contained in the event of a thermal runaway in a cell 302. The space 350 is defined by the protrusion portion of the thermal isolation layers 318, the top (in XY plane away from the cooling plate) of the battery cells 302 and the module cover 108 (not shown).

FIG. 4 shows another aspect of portions of a battery module 400. In the aspect of FIG. 4, a number of cells 402 are shown. In the example, a heat sink 404 is included. A number of thermal isolation structures 410 are shown selectively separating one or more cells 402 within the stack of cells. The thermal isolation structures 410 include a structural support plate 412 similar to examples described above. One or more thermal isolation layers 418 are shown coupled to the structural support plate 412. In the aspect of FIG. 4, a protrusion height 440 of the structural support plate 412 above a top surface of the cells 402 is shown. The protrusion 442 of the structural support plate 412 may have different shapes. In one aspect, the protrusion 442 may be a prism having the same thickness as a thickness of the structural support plate 412. In one aspect, the protrusion 442 may be thicker than the structural support plate 412. In one aspect, the protrusion 442 may have a cross section of semi-circle shape, arch shape, triangle shape, or Y shape. Different cross section shapes help the structural support plate 412 to press against the cover of the module housing and hold the heat isolation structure 410 in place in the battery module. The thermal isolation layers 418 have a height equal to a height of the cells 402. The protrusion height 440 defines a space 450 where gas venting is contained in the event of a thermal runaway in a cell 402. The space 450 is defined by the protrusion portion of the structural support plate 412, the top (in XY plane away from the cooling plate) of the battery cells 402 and the module cover 108 (not shown).

### Configurations of Thermal Isolation Structures

FIGS. 5A, 5B, 5C, and 5D show selected components of a thermal isolation structure 510. In FIGS. 5A and 5B, cross section views of the thermal isolation structure 510 along line BB′ of FIG. 4 are shown. In FIGS. 5C and 5D, cross section views of the thermal isolation structure 510 along line CC′ of FIG. 4 are shown. FIG. 5C is the cross section view of the thermal isolation structure 510 in FIG. 5A along line DD′. FIG. 5D is the cross section view of the thermal isolation structure 510 in FIG. 5B along line EE′.

In the aspect of FIG. 5A, the thermal isolation structure 510 includes a structural support plate 512 and a module cover contact 514. A pair of thermal isolation layers 518 are shown on opposing sides of the structural support plate 512. The module cover contact 514 is a different material from the structural support plate 512. In one example, the module cover contact 514 includes an intumescent material, while the structural support plate 512 includes a material stiffer than the intumescent material. In one example, the structural support plate 512 includes a polymer or a metal. The thermal isolation layers 518 can include aerogel material, which can be fragile. Inclusion of a rigid structural support plate 512 helps support more fragile components such as the thermal isolation layers 518 and the module cover contact 514.

As shown in FIG. 5A, a major surface of the battery cell is indicated by dashed line 502. The thermal isolation layers 518 extends beyond at least one edge of the major surface area of the battery cell 502. In some aspect, the thermal isolation layers 518 extend beyond three edges of the major surface of the battery cell 502 as shown in FIGS. 5A and 5C, leaving the fourth edge of the battery cells 502 to contact the cooling plate for heat transfer.

In the embodiments shown in FIGS. 5A and 5C, the thermal isolation structure 510 includes a structural support plate 512 between two thermal isolation layers 518. The major surface of the isolation layer 518 extends beyond at least one edge of the structural support plate 512, leaving a gap between two thermal isolation layers 518 as shown in FIG. 5C. The module cover contact 514 fills the gap and extends beyond the major surface of the thermal isolation layers 518 as shown in FIGS. 5A and 5C. In one example, the module cover contact 514 includes an intumescent material, while the structural support plate 512 includes a more rigid material.

In the embodiments shown in FIGS. 5B and 5D, the thermal isolation structure 510 includes a structural support plate 512 and the module cover contact 514 along at least one edge of the structural support plate 512. At least one edge of the major surface of the battery cell indicated by the dashed box 502 extends beyond the largest surface of the structural support plate 512. Three edges of the battery cell extend away from the major surfaces of the structural support plate 512 in the aspect shown in FIG. 5B. The periphery of the battery cell (indicated by dashed box 502) is between the periphery of the cover contact 514 and the periphery of the structural support plate 512 in YZ plane.

As shown in FIG. 6, the thermal isolation structure 510 may engage with a slot 507 in a side (a surface parallel to XZ plane) of a module housing 506 (shown only relative portion). The module housing 506 is similar to the module housing 106 in FIG. 1. In addition to the side of the module housing 506 shown in FIG. 6, slot 507 may be in a top (a surface parallel to XY plane) side of a module housing 506. The engaging defines a position for the thermal isolation structure 510 in the module housing 506, thereby keeping thermal isolation structure 510 in place during using of the battery module. An adhesive 509 or resilient material may be included in the slot 507 to help stabilize the thermal isolation structure 510 in the module housing 506.

### Encapsulated Thermal Isolation Structures

FIG. 7A shows an exploded view 700 of one aspect of assembly of a thermal isolation layer 718. In one example, a material for thermal isolation layer 718 includes an aerogel. Aerogel materials can be configured in several forms as described above, and can be made with a variety of chemistry options. An aerogel layer 701 is shown. Aerogel layer 701 may be fragile in such a way that unwanted particles may shed from the layer 701. In the aspect of FIG. 7A, a containment film 704 is shown that is placed to at least partially cover the aerogel layer 701. The containment film encapsulates the thermal isolation layer 718 to prevent dust coming off the thermal isolation layer 718. In the aspect of FIG. 7A, the containment film 704 completely encases the aerogel layer 701 by folding the containment film 704 around all sides of the aerogel layer 701. In one example, the containment film 704 includes a pressure sensitive adhesive that enables the containment film 704 to stick to itself, and enables wrapping without any additional tape or other fasteners.

In one example, a thermal conductor layer 702 is wrapped by the containment film 704 along with the aerogel layer 701. One aspect of a thermal conductor layer 702 includes a metal foil or a graphite plate. Stainless steel foil is one aspect of a metal foil, although other metals or other thermal conductors may also be used. Inclusion of a thermal conductor layer 702 helps to spread heat outwards along a plane of the thermal conductor layer 702 from any local hot spot on a battery cell that the thermal isolation layer 718 may be adjacent to. The inclusion of a thermal conductor layer 702 may also promote channeling of heat from adjacent battery cells to an external heat sink such as heat sinks shown in various examples above. In one aspect, a structural support layer may be included to provide physical support to the aerogel layer 701. The structural support layer may be within or outside of the containment film 704. The structural support layer is more rigid than the aerogel. Examples of the mechanical support layer may be metal, polymer, resin, rubber, mica, and graphite. The structural support layer may be the same as the other structural support layers described herein, such as the structural support layers 112, 312, 412, and 512.

In one example, after wrapping the aerogel layer 701, an adhesive layer 706 is attached to the containment film 704. One aspect of an adhesive layer 706 includes a pressure sensitive adhesive layer. In the aspect of FIG. 7A, a release layer 708 is further included. The release layer 708 is longer than the adhesive layer 706 to provide a tab 712 extending away from the encapsulated thermal isolation layer 718. In operation, the release layer 708 is removed by pulling the tab 712 to expose the adhesive layer 706, which can then be used to attach the thermal isolation layer 718 to a structural support plate (e.g., 312, 412, 512) such as support plates shown in other examples of the present disclosure.

FIG. 7B shows another aspect of an exploded view 720 of a thermal isolation layer 718. In the aspect of FIG. 7B, a first conductor layer 722 and a second conductor layer 723 are sandwiched on either side of an aerogel layer 721. As with the aspect of FIG. 7A, one material for the conductor layers 722, 723 includes a metal foil. Stainless steel foil is one aspect of a metal foil, although other metals or other thermal conductors may also be used. Although a foil is described, various thicknesses of conductor layers may be used, without limitation to any particular foil thickness. A containment film 724 is then used to cover all, or a portion of the laminated stack of layers (722, 721, 723). In one aspect, the containment film 724 encapsulates aerogel layers 721 and conductive layer 722, leaving conductive layers 723 outside the containment film 724. Similar to the aspect in FIG. 7A, at least one of the conductor layers 722 and 723 may be replaced by a structural support layer, such as a mica layer, a polymer layer, and/or a resin layer. The structural support layer may be the same as other structural support layers described herein, such as the structural support layers 112, 312, 412, and 512. In one aspect, at least one of the conductor layers 722 and 723 may be replaced by adhesive layer, such as pressure sensitive adhesive (PSA) layer, to bond the containment film 724 and the aerogel layer 721. In one aspect, the adhesive layer 723 is a PSA layer outside the containment film 724. The adhesive layer 723 glues the encapsulated aerogel layer 721 onto a structural support plate such as structural support plates 312, 412, and 512.

One use of containment film 724, as described above, is to contain any loose particles that may generate from aerogel layer 721. If a conductor layer (722, 723) is included on one or both sides of aerogel layer 721, a containment film 724 may not be needed in addition to the conductor layer. In an aspect where one side of aerogel layer 721 is covered with a conductor layer, only an opposite side of the aerogel layer 721 needs to be covered with containment film 724. In an aspect where both sides of aerogel layer 721 are covered with a conductor layer, only edges of the laminated stack of layers (722, 721, 723) needs to be encapsulated. One method in such a configuration may include sealing only edges of the laminated stack of layers (722, 721, 723) with an adhesive or other edge covering. The edge covering may include rubber, resin, polymer films, etc. although the invention is not so limited.

In one example, a laminated stack of layers (722, 721, 723) as shown in FIG. 7B, or a laminated stack of layers (702, 701) as shown in FIG. 7A is manufactured from a multiple layer sheet, such as a roll. An aerogel layer (701, 721) is rolled out and laminated with one or more conductor layer rolls and a number of rectangles as shown in FIG. 7A or 7B are cut from the laminated rolls or larger sheets. In one example, the aerogel layer and conductor layer are adhered together before cutting. One aspect of cutting from rolls or sheets includes die cutting. Another aspect of cutting from rolls or sheets includes water jet cutting. The laminated stack of layers are further explained with respect to FIG. 16. After laminated rectangles are cut, they can be partially or completely wrapped with a containment film as described above.

### Alternative Configurations of Thermal Isolation Structures

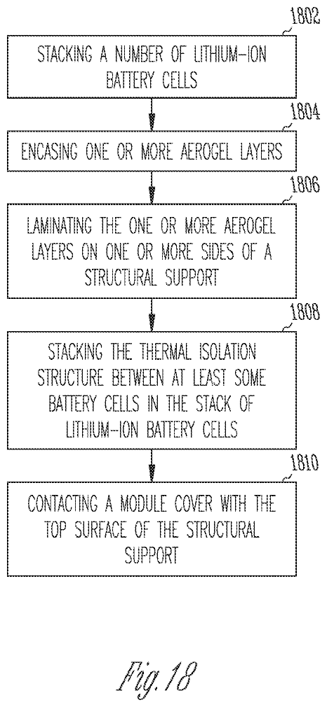

FIGS. 8A and 8B show one aspect of a thermal isolation structure 800 that includes one or more thermal isolation layers 818 and a structural support plate 812 as described in examples of the present disclosure. In the example of FIGS. 8A and 8B, a module cover contact 814 is coupled to, or is integral with a structural support plate 812. In the example of FIGS. 8A and 8B, a top of the module cover contact 814 is flush with a top of the thermal isolation layers 818. The major surface of the structural support plate 812 and the major surface of the thermal isolation layer 818 have the same dimension in YZ plane. The thermal isolation structure 800 is a rectangular lamination.

FIGS. 9A and 9B show one aspect of a thermal isolation structure 900 that includes one or more thermal isolation layers 918 as described in examples of the present disclosure. In the aspect of FIGS. 9A and 9B, a tab 926 is included that is configured to fit into a mating feature in a heat sink or in a bottom of a module housing as described in examples above. In one aspect, the tab 926 is attached to the structural support plate 912 and in contact with the thermal isolation layer 918.

FIGS. 10A, 10B and 10C show examples of thermal isolation structures that include one or more thermal isolation layers as described in examples of the present disclosure. The thermal isolation structure 1000 includes a structural support plate 1012 and at least one thermal isolation layer 1018 attached to major surfaces of the structural support plate 1012. At least one edge of the structural support plate 1012 extends beyond the periphery of the thermal isolation layer 1018. In one aspect, the edge 1002 opposite to the tab 1026 of the structural support plate 1012 extends away from the thermal isolation layer 1018. Edge 1002 is designed to prevent thermal runaway products from traveling to healthy battery cells in the battery module. The edge 1002 may be thicker than the thickness of the structural support layer 1012. The edge 1002 may have a cross section shape of square, rectangular, semi-circle, arch, triangle shape, or Y shape. Different cross section shapes help the structural support plate 1012 to press against the cover of the module housing and hold the heat isolation structure 1000 in place in the battery module. In one aspect, a thickness of the structural support plate 1012 is the same as the thermal isolation layer 1018.

FIG. 10B shows a thermal isolation structure 1020 with a structural support plate 1022 and at least one thermal isolation layer 1028 attached to major surfaces of the structural support plate 1022. The thermal isolation layers 1028 are thinner than the structural support plate 1022. Thin thermal isolation layers 1018 can provide sufficient heat isolation due to the low heat conductivity of the thermal isolation layers 1018 provided in this disclosure compared to other types of thermal isolation layers. The thin thermal isolation layer saves space in the battery module so that more battery cells can be packed for improved energy density.

FIG. 10C shows a thermal isolation structure 1040 with a structural support plate 1042 and at least one thermal isolation layer 1048 attached to major surfaces of the structural support plate 1042. The thermal isolation layers 1048 are thicker than the structural support plate 1042. Thicker thermal isolation layers 1048 provide improved compression to absorb the volume changes of the battery cells during operation. Accommodating the volume changes improves the battery cell cycle life.

### Alternative Encapsulations of Thermal Isolation Structures

FIGS. 11A-11C shows components of one aspect of assembly of a thermal isolation layer 1118. In one example, a material for thermal isolation layer 1118 includes an aerogel. Aerogel materials can be configured in several forms as described above, and can be made with a variety of chemistry options. An aerogel layer 1101 is shown. Aerogel layer 1101 may be fragile in such a way that unwanted particles may shed from the layer 1101. A containment film 1104 is shown in FIG. 11A that is placed to at least partially cover the aerogel layer 1101. The containment film 1104 in the aspect of FIGS. 11A-11C encases major surfaces (in YZ plane) of the aerogel layer 1101 by folding the containment film 1104 around the aerogel layer 1101, leaving only edges exposed (in XZ plane and XY plane). Alternatively, the containment film 1104 may enclose the edges of the aerogel layer 1101. Pre-formed weaknesses 1106 are shown formed in a sheet of the containment film 1104 in FIG. 11B to aid in folding. Examples of weaknesses 1106 include, but are not limited to, scores, cuts, creases, pressed lines, etc.

FIGS. 12A-12C show one aspect of a thermal isolation structure 1220 that includes one or more thermal isolation layers 1218 as described in examples of the present disclosure. In the example of FIGS. 12B and 12C, a module cover contact 1214 is coupled to, or is integral with a structural support plate 1212. FIG. 12A shows a containment film 1204 similar to that shown in FIGS. 11A and 11B but in folded state before wrapping the assembly. In the aspect of FIGS. 12B and 12C, a containment film 1204 is shown that is wrapped around the thermal isolation layers 1218 and the structural support plate 1212. A tab 1226 is included that is configured to fit into a mating feature in a heat sink (not shown) or in a bottom of a module housing (not shown) as described in examples above. The pre-formed weaknesses 1206 correspond to the edges of the thermal isolation structure 1220.

FIGS. 13A-13C show one aspect of a thermal isolation structure 1320 that includes one or more thermal isolation layers 1318 and a structural support plate 1312 as described in examples of the present disclosure. In the example of FIGS. 13B and 13C, a module cover contact 1314 is coupled to, or is integral with a structural support plate 1312. A containment film 1304 is shown that is wrapped around the thermal isolation layers 1318 and the structural support plate 1312. The containment film 1304 similar to that in FIG. 12A is shown in FIG. 13A before wrapping the assembly. A tab 1326 is included that is configured to fit into a mating feature in a heat sink or in a bottom of a module housing as described in examples above. One or more rigid layers 1306 are shown included in the thermal isolation structure 1320. Examples of rigid layer 1306 include, but are not limited to, mica, resin, polymer, rubber, metal, etc. In one example, the rigid layer 1306 provides external structure to further protect the thermal isolation layers 1318, which can be fragile, and prone to grains or dust being knocked off of any exposed surface. In the aspect of FIGS. 13A-13C, the rigid layers 1306 are on an exterior surface of the thermal isolation structure 1320.

FIGS. 14A-14D show one aspect of a thermal isolation structure 1420 that includes one or more thermal isolation layers 1418 and a structural support plate 1412 as described in examples of the present disclosure. In the example of FIGS. 14B and 14C, a module cover contact 1414 is coupled to, or is integral with a structural support plate 1412. A containment film 1404 is shown that is wrapped around the thermal isolation layers 1418 and the structural support plate 1412. The containment film 1404 is shown in FIG. 14A before wrapping the assembly. A tab 1426 is included that is configured to fit into a mating feature in a heat sink or in a bottom of a module housing as described in examples above. One or more rigid layers 1406 are shown included in the thermal isolation structure 1420. The rigid layers 1406 may be disposed outside of the containment film 1404. Examples of rigid layers 1406 include, but are not limited to, mica, resin, polymer, rubber, metal, etc. In one example, the rigid layer 1406 provides external structure to further protect the thermal isolation layers 1418, which can be fragile, and prone to grains or dust being knocked off of any exposed surface. In the aspect of FIGS. 14A-14D, the rigid layers 1406 are further contained in a second containment layer 1408. The second containment layer 1408 protects the rigid layers 1406 from external damage, such as scratches and moisture. The second containment layer 1408 may include different materials from the containment layer 1404 to achieve its protective function. In one example, the combination of two containment layers forms a small gap 1428 between layers 1404, 1408 that is illustrated in FIG. 14D. In one aspect, the small gap 1428 has a triangle shape, one edge of which is the thickness of the rigid layer 1406.

FIGS. 15A-15C show one aspect of a thermal isolation structure 1520 that includes one or more thermal isolation layers 1518 and a structural support plate 1512 as described in examples of the present disclosure. A containment film 1504 is shown that is wrapped around the thermal isolation layers 1518, leaving a portion of the structural support plate 1512 unwrapped. The unwrapped portion of the structural plate 1512 extends away from the thermal isolation layers 1518. The containment film 1504 is shown in FIG. 15A before wrapping the assembly. A more rigid layer 1506 is shown included in the thermal isolation structure 1520. The rigid layer 1506 is wrapped over the containment film 1504 in one example. Examples of rigid layer 1506 include, but are not limited to, mica, resin, polymer, rubber, metal, etc. In one example, the rigid layer 1506 provides external structure to further protect the thermal isolation layers 1518, which can be fragile, and prone to grains or dust being knocked off of any exposed surface. In the aspect of FIGS. 15A-15C, the rigid layer 1506 is on an exterior surface of the thermal isolation structure 1520 outside the containment film 1504.

FIG. 16 shows an aspect of one or more rigid layers 1606 sandwiched between layers of containment film 1604. Using the illustration of FIG. 16, a sheet of laminated containment film 1604 and rigid layer 1606 structures can be roll manufactured, or sheet manufactured and later cut into components for assembly into thermal isolation structures as described in examples above. Prefabricated weaknesses 1607, such as creases, cuts, pressed features, etc. may be included to better facilitate wrapping as shown in examples above.

### Alternative Module Cover Contacts

FIGS. 17A-17C show one aspect of a thermal isolation structure 1720 that includes one or more thermal isolation layers 1718 as described in examples of the present disclosure. In the aspect of FIGS. 17A-17C, a module cover contact 1714 is located on an edge of a structural support plate 1712. Similar to the aspect of FIGS. 5A, 5B and 6, in the aspect of FIGS. 17A-17C the module cover contact 1714 is separate material from the structural support plate 1712. FIG. 17C shows a lap joint 1725 coupling the module cover contact 1714 to the structural support plate 1712, although the invention is not so limited. Other aspect joints 1725 include butt joints, finger joints, dovetail joints and/or other types of joints. In one aspect, the module cover contact 1714 is overmolded to the structural support plate 1712 to enhance the durability of the connection therebetween. In one aspect, the module cover contact includes a key portion extending into a keyway in the structural support plate 1712 for improved connection. In one aspect, the module cover contact has the same thickness than that of the structural support plate 1712. In one aspect, the thickness of the module cover contact 1714 may be greater than that of the structural support plate 1712. In one aspect, the module cover contact 1714 may have a cross section of semi-circle shape, arch shape, triangle shape, or Y shape. Different thickness and cross section shapes help the structural support plate 1712 to press against the cover of the module housing and hold the heat isolation structure 1720 in place in the battery module.

In one example, the module cover contact 1714 includes an intumescent material, while the structural support plate 1712 includes a more rigid material. In one aspect, the structural support plate 1712 includes metals such as aluminum, stainless steel, titanium, other metal, or metal alloys. In one aspect, the structural support plate 1712 includes mica, graphite, plastic, polymer, rubber, or other materials that are more rigid than the thermal isolation layer 1718. In the aspect of FIGS. 17A-17C, a width of the module cover contact 1714 is substantially the same as a width of the structural support plate 1712.

FIG. 18 shows a flow diagram of a method of manufacture. In operation 1802, a number of lithium-ion cells are stacked. In operation 1804, one or more aerogel layers are encased. In operation 1806, the one or more aerogel layers are laminated on one or more sides of a structural support. In operation 1808, the thermal isolation structure is stacked between at least some cells in the stack of lithium-ion cells. In operation 1810, a module cover is contacted with the top surface of the structural support.

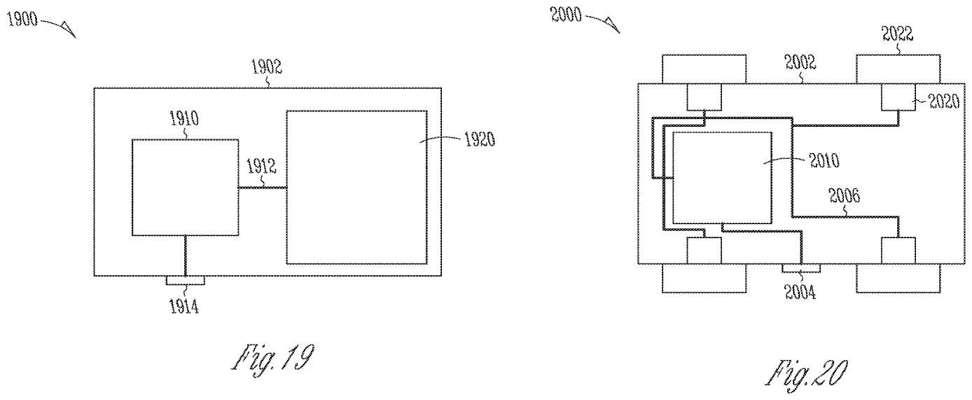

Battery modules as described above are used in a number of electronic devices. FIG. 19 illustrates an example electronic device 1900 that includes a battery module 1910. The battery module 1910 is coupled to functional electronics 1920 by circuitry 1912. In the aspect shown, the battery module 1910 and circuitry 1912 are contained in a housing 1902. A charge port 1914 is shown coupled to the battery module 1910 to facilitate recharging of the battery module 1910 when needed.

In one example, the functional electronics 1920 include devices such as semiconductor devices with transistors and storage circuits. Examples include, but are not limited to, telephones, computers, display screens, navigation systems, etc.

FIG. 20 illustrates another electronic system that utilizes battery modules that include multilayer thermal barriers as described above. An electric vehicle 2000 is illustrated in FIG. 20. The electric vehicle 2000 includes a chassis 2002 and wheels 2022. In the aspect shown, each wheel 2022 is coupled to a drive motor 2020. A battery module 2010 is shown coupled to the drive motors 2020 by circuitry 2006. A charge port 2004 is shown coupled to the battery module 2010 to facilitate recharging of the battery module 2010 when needed.

Examples of electric vehicle 2000 include, but are not limited to, consumer vehicles such as cars, trucks, etc. Commercial vehicles such as tractors and semi-trucks are also within the scope of the invention. Although a four wheeled vehicle is shown, the invention is not so limited. For example, two wheeled vehicles such as motorcycles and scooters are also within the scope of the invention.

To better illustrate the method and apparatuses disclosed herein, a non-limiting list of embodiments is provided here:

Aspect 1. A thermal isolation structure for a battery module, comprising: a structural support plate having a first width, a module cover contact located on a top end of the structural support plate; and a thermal isolation layer coupled to at least one side of the structural support plate.

Aspect 2. The thermal isolation structure of aspect 1, wherein the thermal isolation layer includes an aerogel material.

Aspect 3. The thermal isolation structure of aspect 1, wherein the structural support plate includes an intumescent material.

Aspect 4. The thermal isolation structure of aspect 1, wherein the module cover contact includes an intumescent material.

Aspect 5. The thermal isolation structure of aspect 1, wherein the thermal isolation layer includes two aerogel thermal isolation layers, and wherein the two aerogel thermal isolation layers are coupled on either side of the structural support plate.

Aspect 6. The thermal isolation structure of aspect 5, wherein the two aerogel thermal isolation layers are each at least partially covered with a containment film.

Aspect 7. A battery module, comprising: a stack of lithium-ion cells located within a module housing; a thermal isolation structure between at least two cells in the stack of lithium-ion cells, the thermal isolation structure including; a structural support plate; a module cover contact located on a top end of the structural support plate; and an aerogel layer coupled to at least one side of the structural support plate; a module cover over the stack of lithium-ion cells in contact with the module cover contact, wherein the module cover encloses the stack of lithium-ion cells within the module housing.

Aspect 8. The battery module of aspect 7, wherein the aerogel layer is at least partially covered with a containment film.

Aspect 9. The battery module of aspect 8, further including a metal foil layer wrapped with the aerogel layer.

Aspect 10. The battery module of aspect 7, further including a heat sink coupled to an edge of the stack of lithium-ion cells.

Aspect 11. The battery module of aspect 7, wherein the thermal isolation structure includes multiple thermal isolation structures, and wherein an individual thermal isolation structure of the multiple thermal isolation structures is included between each cell in the stack of lithium-ion cells.

Aspect 12. The battery module of aspect 11, wherein sides of the structural support plate interlocks with sides of the module housing.

Aspect 13. The battery module of aspect 12, wherein a bottom of the structural support plate interlocks with a heat sink at a bottom of the module housing.

Aspect 14. The battery module of aspect 7, wherein the structural support plate includes a first material for a central body portion, and a second material for the module cover contact.

Aspect 15. The battery module of aspect 14, wherein the second material includes an intumescent material.

Aspect 16. A method of forming a battery module, comprising: stacking a number of lithium-ion cells; forming a thermal isolation structure including; encasing one or more aerogel layers; laminating the one or more aerogel layers on one or more sides of a structural support; stacking the thermal isolation structure between at least some cells in the stack of lithium-ion cells; and contacting a module cover with a top surface of the structural support.

Aspect 17. The method of aspect 16, wherein encasing one or more aerogel layers includes encasing after laminating the one or more aerogel layers on one or more sides of the structural support.

Aspect 18. The method of aspect 16, wherein encasing one or more aerogel layers includes encasing before laminating the one or more aerogel layers on one or more sides of the structural support.

Aspect 19. The method of aspect 16, wherein encasing one or more aerogel layers includes wrapping a flexible film around all sides of the one or more aerogel layers.

Aspect 20. The method of aspect 16, wherein laminating the one or more aerogel layers on one or more sides of a structural support includes using a pressure sensitive adhesive to attach the one or more aerogel layers to the structural support.

Aspect 21. The method of aspect 16, wherein contacting a module cover with the top surface of the structural support includes placing an intermediate resilient pad between the module cover and the top surface of the structural support.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Although an overview of the inventive subject matter has been described with reference to specific aspects, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the aspect configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific aspects. However, the illustrative discussions above are not intended to be exhaustive or to limit the possible aspects to the precise forms disclosed. Many modifications and variations are possible in view of the above teachings. The aspects were chosen and described in order to best explain the principles involved and their practical applications, to thereby enable others skilled in the art to best utilize the various aspects with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present aspects. The first contact and the second contact are both contacts, but they are not the same contact.

The terminology used in the description of the aspects herein is for the purpose of describing particular aspects only and is not intended to be limiting. As used in the description of the aspects and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A thermal isolation structure for a battery module, comprising:
a structural support plate having a first width;
a module cover contact located on a top end of the structural support plate; and
a thermal isolation layer coupled to at least one side of the structural support plate.

2. The thermal isolation structure of claim 1, wherein the thermal isolation layer includes an aerogel material.

3. The thermal isolation structure of claim 1, wherein the structural support plate includes an intumescent material.

4. The thermal isolation structure of claim 1, wherein the module cover contact includes an intumescent material.

5. The thermal isolation structure of claim 1, wherein the thermal isolation layer includes two aerogel thermal isolation layers, and wherein the two aerogel thermal isolation layers are coupled on either side of the structural support plate.

6. The thermal isolation structure of claim 5, wherein the two aerogel thermal isolation layers are each at least partially covered with a containment film.

7. A battery module, comprising:
a stack of lithium-ion cells located within a module housing;
a thermal isolation structure between at least two cells in the stack of lithium-ion cells, the thermal isolation structure including:
a structural support plate;
a module cover contact located on a top end of the structural support plate; and
an aerogel layer coupled to at least one side of the structural support plate;
a module cover over the stack of lithium-ion cells in contact with the module cover contact, wherein the module cover encloses the stack of lithium-ion cells within the module housing.

8. The battery module of claim 7, wherein the aerogel layer is at least partially covered with a containment film.

9. The battery module of claim 8, further including a metal foil layer wrapped with the aerogel layer.

10. The battery module of claim 7, further including a heat sink coupled to an edge of the stack of lithium-ion cells.

11. The battery module of claim 7, wherein the thermal isolation structure includes multiple thermal isolation structures, and wherein an individual thermal isolation structure of the multiple thermal isolation structures is included between each cell in the stack of lithium-ion cells.

12. The battery module of claim 11, wherein sides of the structural support plate interlocks with sides of the module housing.

13. The battery module of claim 12, wherein a bottom of the structural support plate interlocks with a heat sink at a bottom of the module housing.

14. The battery module of claim 7, wherein the structural support plate includes a first material for a central body portion, and a second material for the module cover contact.

15. The battery module of claim 14, wherein the second material includes an intumescent material.

16. A method of forming a battery module, comprising:
stacking a number of lithium-ion cells;
forming a thermal isolation structure including:
encasing one or more aerogel layers;
laminating the one or more aerogel layers on one or more sides of a structural support;
stacking the thermal isolation structure between at least some cells in the stack of lithium-ion cells; and
contacting a module cover with a top surface of the structural support.

17. The method of claim 16, wherein encasing one or more aerogel layers includes encasing after laminating the one or more aerogel layers on one or more sides of the structural support.

18. The method of claim 16, wherein encasing one or more aerogel layers includes encasing before laminating the one or more aerogel layers on one or more sides of the structural support.

19. The method of claim 16, wherein encasing one or more aerogel layers includes wrapping a flexible film around all sides of the one or more aerogel layers.

20. The method of claim 16, wherein laminating the one or more aerogel layers on one or more sides of a structural support includes using a pressure sensitive adhesive to attach the one or more aerogel layers to the structural support.

21. The method of claim 16, wherein contacting a module cover with the top surface of the structural support includes placing an intermediate resilient pad between the module cover and the top surface of the structural support.
